(19) United States
(12) Patent Application Publication
(10) Pub. No.: US 2015/0093072 A1
(43) Pub. Date: Apr. 2, 2015

(54) OPTICAL DEVICE WITH HIGH DAMAGE THRESHOLD

(71) Applicant: Electronics and Telecommunications Research Institute, Daejeon (KR)

(72) Inventors: Won Bae CHO, Daejeon (KR); Moon Youn JUNG, Daejeon (KR); Hwang Woon LEE, Daejeon (KR); Fabian ROTERMUND, Seoul (KR); Sun Young CHOI, Anyang (KR)

(21) Appl. No.: 14/480,504

(22) Filed: Sep. 8, 2014

(30) Foreign Application Priority Data
Oct. 1, 2013 (KR) 10-2013-0117368
Dec. 31, 2013 (KR) 10-2013-0168937

(51) Int. Cl. G02B 6/35

(52) U.S. Cl. CPC G02B 6/3512
USPC 385/18; 385/16

(57) ABSTRACT

Provided is an optical device having a high damage threshold, the optical device including a coating layer applied to cover a substrate and an optical switch formed of a carbon material and disposed on one side of the substrate, which may have a greatly increased damage threshold through the coating layer and thus, a characteristic of the optical device may be effectively adjusted.

### CROSS-REFERENCE TO RELATED APPLICATION

This application claims the priority benefit of Korean Patent Application No. 10-2013-0117368, filed on Oct. 1, 2013, and Korean Patent Application No. 10-2013-0168937, filed on Dec. 31, 2013, in the Korean Intellectual Property Office, the disclosures of which are incorporated herein by reference.

### BACKGROUND

1. Field of the Invention

Embodiments of the present invention relate to an optical device having a high damage threshold using a coating layer applied to cover a substrate and an optical switch.

2. Description of the Related Art

In general, an optical fiber laser may have an output that is generally lower than that of other solid-state laser systems. Thus, an optical switch to be embedded in the optical fiber laser may be usable without difficulty, despite a relatively low damage threshold. However, an optical device of a solid-state laser that is widely used to manufacture a high-power laser system may require a high damage threshold.

Recently, optical fiber lasers or solid-state lasers to which saturable absorbers are applied have been drawing considerable interest. However, when the saturable absorbers are formed of a carbon material including graphene or carbon nanotubes, the saturable absorbers may receive a focused high-energy laser beam when the saturable absorbers are exposed to air. Here, such a carbon-based material may be combined with oxygen resulting in combustion and destruction of the saturable absorbers.

For this reason, the optical fiber laser with the saturable absorbers may generally be used for low-power level lasers. In the solid-state lasers, to exceed damage threshold of the saturable absorbers, it may apply a method of lowering effective energy by magnifying the size of a beam irradiated to the optical device. However, when a small size of a focused beam in the solid-state laser is inevitably required, a complicated and inconvenient process of injecting nitrogen gas and reducing reactivity to oxygen may be applied for use of the solid-state laser.

Thus, a method of improving a function or a damage threshold of the saturable absorbers using a carbon material functionalized using graphene, carbon nanotube, graphene oxide, flakes of each carbon material, or various chemical reactions may be applied. However, suitable technology and materials have yet to be obtained.

### SUMMARY

An aspect of the present invention provides an optical device that may have an increased damage threshold and durability by preventing an optical switch from coming into contact with air by using a coating layer.

Another aspect of the present invention also provides an optical device that may have an increased characteristic of the optical device using anti-reflection or partial reflection dielectric coating and effectively adjusts an amount of energy saturating the optical device.

Still another aspect of the present invention also provides an optical device that may be used in a wide range of applications including a high-powered laser system.

According to an aspect of the present invention, there is provided an optical device including a substrate, an optical switch formed of a carbon material and disposed on one side of the substrate, and a coating layer to cover the substrate and the optical switch.

The optical switch may be partially disposed on the side of the substrate.

The optical switch may be composed of a material having a saturable absorption property in each wavelength domain.

The coating layer may be formed by anti-reflection dielectric coating.

The coating layer may be formed by partial reflection dielectric coating. The dielectric coating may adjust an amount of energy saturating the optical switch based on a predetermined reflectance.

According to another aspect of the present invention, there is provided an optical device including a substrate, an optical switch formed by combining a carbon material and a composite material and disposed on one side of the substrate, and a coating layer to cover the substrate and the optical switch.

The optical switch may be composed of a material having a saturable absorption property in each wavelength domain.

The optical switch may be formed by combining a carbon material and a composite material having a glass transition temperature higher than a processing temperature for the optical device.

The optical switch may be formed by combining a carbon material and a composite material having a transmittance higher than a predetermined transmittance in a wavelength domain of the optical device.

The coating layer may be formed of a dielectric coating processed at a temperature lower than a predetermined temperature.

According to still another aspect of the present invention, there is provided an optical device including a substrate, an optical switch formed of a carbon material and disposed on one side of the substrate, a coating layer applied to cover the substrate and the optical switch, and a mirror disposed between the coating layer and the substrate.

The optical switch may be partially disposed on the side of the substrate.

The optical switch may be composed of a material having a saturable absorption property in each wavelength domain.

The coating layer may be formed by anti-reflection dielectric coating.

The coating layer may be formed by partial reflection dielectric coating. The dielectric coating may adjust an amount of energy saturating the optical switch based on a predetermined reflectance.

According to yet another aspect of the present invention, there is provided an optical device including a substrate, an optical switch formed by combining a carbon material and a composite material and being disposed on one side of the substrate, a coating layer applied to cover the substrate and the optical switch, and a mirror disposed between the coating layer and the substrate.

The optical switch may be composed of a material having a saturable absorption property in each wavelength domain.

The optical switch may be formed by combining a carbon material and a composite material having a glass transition temperature higher than a processing temperature for the optical device.

The optical switch may be formed by combining a carbon material and a composite material having a transmittance higher than a predetermined transmittance in a wavelength domain of the optical device.

The coating layer may be formed of a dielectric coating processed at a temperature lower than a predetermined temperature.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a plan view and a cross-sectional view of an optical device according to an embodiment of the present invention;

FIG. 2 is a cross-sectional view of a transmissive optical device according to an embodiment of the present invention;

FIG. 3 is a cross-sectional view of a reflective optical device according to an embodiment of the present invention; and

FIG. 4 is a graph illustrating an amount of energy saturating an optical device according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

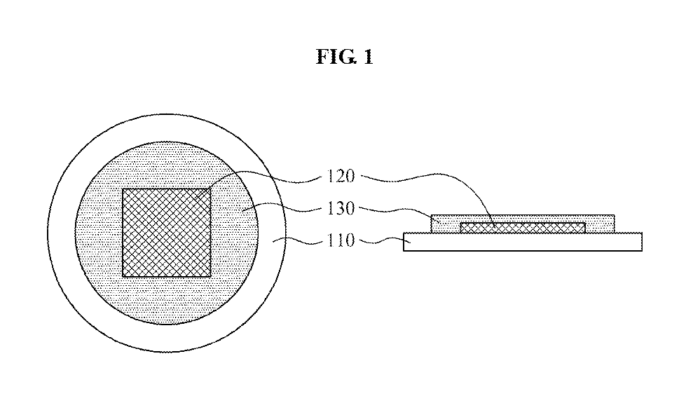

FIG. 1 is a plan view and cross-sectional view illustrating an optical device according to an embodiment of the present invention.

Referring to FIG. 1, the optical device may include a substrate 110, an optical switch 120, and a coating layer 130.

The substrate 110 may be an optical component of any type including a general type laser mirror and a transparent substrate. For example, the transparent substrate may include BK7 which is an optical glass and quartz. The optical switch 120 may be disposed on one side of the substrate 110.

The optical switch 120 may be a component to be disposed on one side of the substrate 110. The optical switch 120 may be turned on when an amount of energy to be irradiated is greater than a predetermined threshold. Conversely, the optical switch 120 may be turned off when an amount of energy to be irradiated is less than the predetermined threshold.

The optical switch 120 may be composed of a material having a saturable absorption property in each wavelength domain. Here, the material having the saturable absorption property may be formed of a carbon material or by combining the carbon material and a composite material. The optical switch 120 may be formed of the carbon material or by combining the carbon material and the composite material.

In an example, the optical switch 120 may be formed by independently applying the carbon material. Here, the carbon material may refer to a material composed of carbon including graphene and carbon nanotube and unmixed with other materials.

The optical switch 120 may be partially disposed only on the side of the substrate 110. The optical switch 120 may occupy only a portion of a total area of the substrate 110.

In another example, the optical switch 120 may be formed by combining the carbon material and the composite material. In general, the coating layer 130 may be formed at a processing temperature in a range of 50 to 200° C. Here, no issues may arise because the carbon material may have a glass transition temperature (Tg) higher than the processing temperature. However, when the composite material has a Tg lower than the processing temperature for the optical device, the composite material may melt during a process of processing the optical device. Thus, the composite material may be required to have a Tg higher than the processing temperature for the optical device.

The Tg may refer to a temperature at a point in time at which molecules of a polymer activate and are realigned by heat. The Tg may refer to a temperature at a point in time at which polymer is changed to be an elastic material before transitioning from a solid to a liquid. The Tg may be observed only in a polymeric material.

The composite material may have a transmittance higher than a predetermined transmittance in a wavelength domain of the optical device. The optical switch 120 may be formed by combining the carbon material and the composite material having the transmittance higher than the predetermined transmittance in the wavelength domain of the optical device.

When the composite material has a Tg lower than a processing temperature for a general optical device, the coating layer 130 may be required to be formed through a low-temperature dielectric coating process. The coating layer 130 may be formed of a dielectric coating processed at a temperature lower than a predetermined temperature.

However, forming the optical switch 120 by applying the carbon material exclusively may have advantages in terms of product safety due to limitations that may be caused when forming the optical switch 120 by combining the carbon material and the composite material.

The coating layer 130 may be applied to cover the substrate 110 and the optical switch 120. In an example, the coating layer 130 may be coated to cover the substrate 110 and the optical switch 120 through dielectric coating.

The coating layer 130 may greatly increase an adhesive force of the optical switch 120 to the substrate 110. The coating layer 120 may provide an additional adhesive force to the optical switch 120 in addition to a fundamental van der Waals force.

Also, the coating layer 130 may significantly reduce a size of an area in which the optical switch 120 is in contact with air. Thus, the coating layer 130 may prevent combustion caused by the air from occurring in the optical switch 120. Further, the coating layer 130 may greatly increase a damage threshold of the optical device.

In an example, the coating layer 130 may be formed using the anti-reflection dielectric coating. In another example, the coating layer 130 may be formed using the partial reflection dielectric coating. Here, the dielectric coating may adjust an amount of energy saturating the optical switch 120 based on a predetermined reflectance.

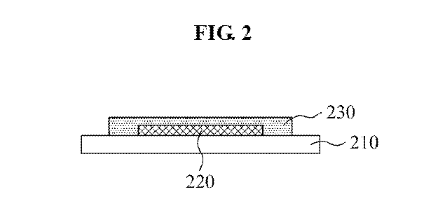

FIG. 2 is cross-sectional view illustrating a configuration of a transmissive optical device according to an embodiment of the present invention.

Referring to FIG. 2, the transmissive optical device may include a substrate 210, an optical switch 220, and a coating layer 230. The transmissive optical device may refer to an optical device without a mirror and allow transmission of light.

The substrate 210 may be an optical component of any type including a general type laser mirror and a transparent substrate. For example, the transparent substrate may include BK7 and quartz. On one side of the substrate 210, the optical switch 220 may be disposed. For example, the substrate 210 may be an end of an uncoated optical fiber.

The optical switch 220 may be a component to be disposed on one side of the substrate 210. The optical switch 220 may be turned on when an amount of energy to be irradiated is greater than a predetermined threshold. Conversely, the optical switch 220 may be turned off when an amount of energy to be irradiated is less than the predetermined threshold.

The optical switch 220 may be composed of a material having a saturable absorption property in each wavelength domain. Here, the material having the saturable absorption property may be formed of a carbon material or by combining the carbon material and a composite material. The optical switch 220 may be formed of the carbon material or by combining the carbon material and the composite material.

In an example, the optical switch 220 may be formed by applying the carbon material independently. Here, the carbon material may refer to a material composed of carbon including graphene and carbon nanotubes, and unmixed with other materials.

The optical switch 220 may be partially disposed on the side of the substrate 210. The optical switch 220 may occupy only a portion of a total area of the substrate 210.

In another example, the optical switch 220 may be formed by combining the carbon material and the composite material. In general, the coating layer 230 may be formed at a processing temperature in a range of 50 to 200° C. Here, no issue may be found because the carbon material may have a Tg higher than the processing temperature. However, when the composite material has a Tg lower than the processing temperature for the optical device, the composite material may melt during a process of processing the optical device. Thus, the composite material may be required to have a Tg higher than the processing temperature for the optical device.

The composite material may have a transmittance higher than a predetermined transmittance in a wavelength domain of the optical device. The optical switch 220 may be formed by combining the carbon material and the composite material having the transmittance higher than the predetermined transmittance in the wavelength domain of the optical device.

When the composite material has a Tg lower than a processing temperature for a general optical device, formation of the coating layer 230 through a low-temperature dielectric coating process may be required. The coating layer 230 may be formed of a dielectric coating processed at a temperature lower than a predetermined temperature.

The coating layer 230 may be applied to cover the substrate 210 and the optical switch 220. The coating layer 230 may be applied to cover the substrate 210 and the optical switch 220 through the dielectric coating.

In an example, the coating layer 230 may be formed by anti-reflection dielectric coating. In another example, the coating layer 230 may be formed by partial reflection dielectric coating. Here, the dielectric coating may be used to adjust an amount of energy saturating the optical switch 220 based on a predetermined reflectance.

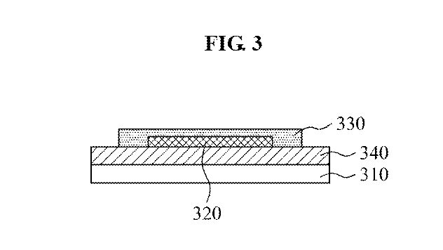

FIG. 3 is cross-sectional view illustrating a configuration of a reflective optical device according to an embodiment of the present invention.

Referring to FIG. 3, the reflective optical device may include a substrate 310, an optical switch 320, a coating layer 330, and a mirror 340. The reflective optical device may refer to an optical device that additionally includes the mirror 340 and reflects light.

The substrate 310 may be an optical component of any type including a general type laser mirror and a transparent substrate. For example, the transparent substrate may include BK7 and quartz. On one side of the substrate 310, the optical switch 320 may be disposed.

The optical switch 320 may be a component to be disposed on one side of the substrate 310. The optical switch 320 may be turned on when an amount of energy to be irradiated is greater than a predetermined threshold. Conversely, the optical switch 320 may be turned off when an amount of energy to be irradiated is less than the predetermined threshold.

The optical switch 320 may be composed of a material having a saturable absorption property in each wavelength domain. Here, the material having the saturable absorption property may be formed of a carbon material or by combining the carbon material and a composite material. The optical switch 320 may be formed of the carbon material or by combining the carbon material and the composite material.

The coating layer 330 may be applied to cover the substrate 310 and the optical switch 320. The coating layer 330 may be applied to cover the substrate 310 and the optical switch 320 through dielectric coating.

The mirror 340 may be composed of a bragg reflector based on stacks of dielectric coatings and high reflecting metal mirrors.

In an example, the coating layer 330 may be formed by anti-reflection dielectric coating. In another example, the coating layer 330 may be formed by partial reflection dielectric coating. Here, the dielectric coating may be used to adjust an amount of energy saturating the optical switch 320 based on a predetermined reflectance.

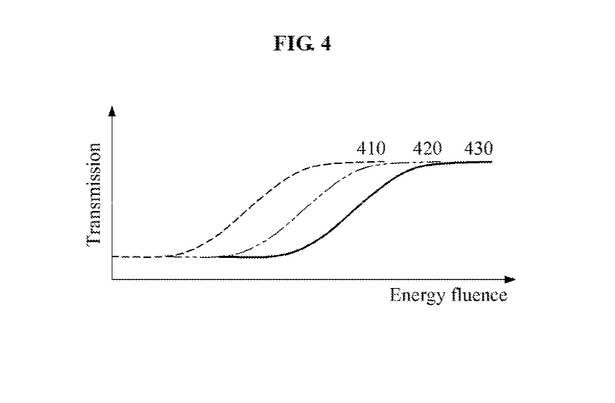

FIG. 4 is a graph illustrating an amount of energy saturating an optical device according to an embodiment of the present invention.

Referring to the graph of FIG. 4, a horizontal axis indicates an amount of energy, for example, energy fluence, and a vertical axis indicates transmission of the optical device.

A coating layer may be formed by a dielectric coating having a characteristic of anti-reflection or partial reflection. Thus, the coating layer may greatly reduce a reflection loss that may be caused by a carbon material having a refractive index of approximately 2 and adjust an amount of energy saturating an optical switch.

In an example, cases indicated as 410, 420, and 430 in FIG. 4 may indicate transmission of the optical device based on a reflectance of the coating layer. Case 410 indicates an example in which the coating layer is formed by anti-reflection dielectric coating. Case 420 indicates an example in which the coating layer is formed by 50% partial reflective coating. Case 430 indicates an example in which the coating layer is formed by 90% partial reflective coating.

Here, the coating layer formed by the 90% partial reflective coating may indicate that an amount of energy reaching the optical switch may occupy 10% of a total amount of energy irradiated to the optical device.

As illustrated in FIG. 4, the graph moves from left to right as cases moves from case 410 to case 430, which may convey that an amount of energy required for normal operation of the optical switch may increase as the coating layer is formed by reflective coating with a higher reflectance. Thus, when the coating layer is formed by the reflective coating with the higher reflection, a damage threshold of the optical device may increase.

According to an embodiment of the present invention, using a coating layer may prevent an optical switch from coming into contact with air and thus, increase a damage threshold and durability of an optical device.

According to an embodiment of the present invention, using anti-reflection or partial reflection dielectric coating may increase a characteristic of an optical device and effectively adjust an amount of energy saturating the optical device.

According to an embodiment of the present invention, an optical device may be applicable to a wide range of applications including a high-power laser system and the like.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical device, comprising:
a substrate;
an optical switch formed of a carbon material and disposed on one side of the substrate; and
a coating layer coated to cover the substrate and the optical switch.

2. The optical device of claim 1, wherein the optical switch is partially disposed on the side of the substrate.

3. The optical device of claim 1, wherein the optical switch is composed of a material having a saturable absorption property in each wavelength domain.

4. The optical device of claim 1, wherein the coating layer is formed by anti-reflection dielectric coating.

5. The optical device of claim 1, wherein the coating layer is formed by partial reflection dielectric coating, and
wherein the dielectric coating adjusts an amount of energy saturating the optical switch based on a predetermined reflectance.

6. The optical device of claim 1, further comprising
a mirror disposed between the coating layer and the substrate.

7. An optical device, comprising:
a substrate;
an optical switch formed by combining a carbon material and a composite material and disposed on one side of the substrate; and
a coating layer coated to cover the substrate and the optical switch.

8. The optical device of claim 7, wherein the optical switch is composed of a material having a saturated absorption characteristic in each wavelength domain.

9. The optical device of claim 7, wherein the optical switch is formed by combining a carbon material and a composite material having a glass transition temperature higher than a processing temperature for the optical device.

10. The optical device of claim 7, wherein the optical switch is formed by combining a carbon material and a composite material having a transmittance higher than a predetermined transmittance in a wavelength domain of the optical device.

11. The optical device of claim 7, wherein the coating layer is formed of a dielectric coating processed at a temperature lower than a predetermined temperature.

12. The optical device of claim 7, further comprising:
a mirror disposed between the coating layer and the substrate.
